(19) United States
(12) Patent Application Publication
(10) Pub. No.: US 2021/0370801 A1
(43) Pub. Date: Dec. 2, 2021

(54) METHOD FOR A VEHICLE SEAT, COMPUTER PROGRAM, MEMORY MEDIUM AND DEVICE

(71) Applicant: Robert Bosch GmbH, Stuttgart (DE)

(72) Inventors: Andreas Schulz, Loewenstein-Hoesslinsuelz (DE); Willy Klier, Yokohama-shi, Kanagawa (JP); Armin Koehler, Sachsenheim (DE); Heiko Freienstein, Weil Der Stadt (DE)

(21) Appl. No.: 16/341,557

(22) PCT Filed: Oct. 14, 2016
(86) PCT No.: PCT/EP2016/074698

§ 371 Date: Apr. 12, 2019

(51) Int. Cl. B60N 2/02; B60N 2/00

(52) U.S. Cl. CPC B60N 2/0244; B60N 2002/981; B60N 2/002

(57) ABSTRACT

A method for determining an adjustment of a vehicle seat in a vehicle having at least one occupant-protection arrangement, in which an occupant type of an occupant is ascertained when the occupant enters the vehicle, and an adjustment of the vehicle seat is determined as a function of the ascertained occupant type, so that the determined occupant type is optimally aligned with respect to the at least one occupant-protection arrangement of the vehicle.

### FIELD OF THE INVENTION

The present invention relates to a method for determining an adjustment of a vehicle seat, a method for warning a vehicle occupant, and a method for adjusting a vehicle seat; it also relates to a corresponding computer program, a corresponding machine-readable memory medium as well as a corresponding device.

### BACKGROUND INFORMATION

Automatically adjustable vehicle seats, in particular electrically adjustable vehicle seats, are already known and frequently installed in modern vehicles.

It is also believed to be understood that the effectiveness of occupant-protection arrangement depends on the seating position of the occupant in relation to the occupant-protection arrangement.

### SUMMARY OF THE INVENTION

The present invention uses this background as the starting point. Toward this end, the present invention provides a method for determining an adjustment of a vehicle seat, a method for warning an occupant of a vehicle as well as a method for adjusting a vehicle seat. In addition, the present invention relates to a corresponding computer program, an associated machine-readable memory medium and to a corresponding device, in particular a control unit.

The present method for determining an adjustment of a vehicle seat of a vehicle equipped with at least one occupant-protection arrangement includes the ascertainment of an occupant type of an occupant who is getting into the vehicle, and a determination of the adjustment of the vehicle seat as a function of the ascertained occupant type, so that the determined occupant type is optimally aligned in relation to the at least one occupant-protection arrangement of the vehicle.

According to the present invention, an adjustment of a vehicle seat may be understood at least as an adjustment of the seat height, the position of the seat on the adjustment rail, the inclination of the backrest or the seat cushion. Also encompassed by the present invention are further adjustable elements of a vehicle seat.

In this instance, occupant protection arrangement is to be understood as an arrangement suitable for preventing, either entirely or at least partially, the injury that an occupant would sustain in the event of an accident. Among these arrangements are airbags, seat-belt pretensioners as well as active headrests and lateral seat supports.

This method offers the advantage that an optimal alignment of the occupant in relation to the at least one occupant-protection arrangement in the vehicle is provided. This increases the overall effectiveness of the at least one occupant-protection arrangement.

In one advantageous specific embodiment of the present method, the occupant type is ascertained with the aid of a device for interior monitoring. One particularly suitable device for interior monitoring is a camera for monitoring the vehicle interior. The use of corresponding cameras for monitoring an interior makes it possible not only to ascertain the height and the gender of the occupant but also the mass of the occupant. Alternatively or additionally, arrangement for detecting the mass of the occupant, such as weight mats in the seat surface of the vehicle seat, may also be used for determining the individual occupant type.

Another aspect of the present invention is a method for warning an occupant of a vehicle. In this case, an adjustment is determined according to one of the preceding embodiments of the method for determining an adjustment of a vehicle seat. If the determined adjustment does not agree with the current adjustment of the vehicle seat, then the occupant will be warned. According to the present invention, adjustments for a vehicle seat are in agreement when the adjustable parameters between the determined adjustment and the current adjustment agree within the scope of the usual tolerances. In this context, the parameters may pertain to the pivoting, tilting or shifting elements of the vehicle seat. When a warning of an occupant is mentioned, this may mean that acoustic or haptic warning arrangement as well as video warning arrangement are actuated accordingly.

The warning of the occupant may be easily accomplished using a blinking light or a regularly beeping tone. In addition, the frequency of the blinking or beeping may be a function of the speed of the vehicle and be carried out at a correspondingly higher frequency as the speed of the vehicle increases. A haptic warning in the case of an at least partially electrically adjustable seat may be implemented via the adjustment motors. Alternatively or additionally, an electric belt pretensioner is able to be actuated in order to generate a haptic warning.

According to one advantageous embodiment of the present method for warning an occupant, the current adjustment of the vehicle seat is ascertained with the aid of the previously introduced interior monitoring device. Alternatively or additionally, the current adjustment is able to be ascertained using at least one device for detecting a seat adjustment.

One further aspect of the present invention is a method for adjusting a vehicle seat. In this case, an adjustment is determined according to one of the above embodiments of the present method for determining an adjustment of a vehicle seat, and the vehicle seat is automatically brought into the determined alignment. One prerequisite for this specific embodiment of the present method is that the vehicle seat be at least partially automatically adjustable. It is particularly advantageous if the vehicle seat is electrically adjustable.

This method offers the advantage that the occupant has a positive user experience when—through the adjustment of the vehicle seat or after getting into the vehicle—the user experiences how the vehicle seat adjusts to his occupant type in an individualized manner.

According to one advantageous specific embodiment of the present method for adjusting a vehicle seat, the vehicle seat is brought into the determined alignment as a function of a confirmation from the occupant.

According to one advantageous specific embodiment of the method for adjusting a vehicle seat, the vehicle seat is brought into the determined alignment as a function of the driving state of the vehicle. In this instance, it has shown to be particularly advantageous to move the vehicle seat into the determined alignment when the vehicle is in the standstill driving state. This increases the safety during the adjustment of the vehicle seat because the occupant, if it involves the driver, will not be distracted by the automatic adjustment of the vehicle seat while carrying out the driving task.

The present invention is particularly focused on comparing the adjustment of the vehicle seat to the occupant when the occupant is getting into the car. In the same way, the present invention may be used when the occupant modifies the adjustment of the vehicle seat while driving. The check may then be carried out anew and a warning or an automatic adjustment be implemented, as the case may be.

One further aspect of the present invention is a computer program, which is set up to carry out the steps of the method described above.

Another aspect of the present invention is a machine-readable memory medium on which the aforementioned computer program is stored.

One additional aspect of the present invention is a device, which is configured to carry out the steps according to one of the previously described methods.

A corresponding control unit has been shown to be particularly useful as a device.

In the following text, specific embodiments of the present invention are illustrated and described on the basis of figures.

### BRIEF DESCRIPTION OF THE DRAWINGS

FIG. 1 shows a flow diagram of a specific embodiment of a method for determining an adjustment of a vehicle seat.

FIG. 2 shows a flow diagram of a specific embodiment of a method for warning an occupant.

FIG. 3 shows a flow diagram of a specific embodiment of a method for adjusting a vehicle seat.

FIG. 4 shows a block diagram of the present invention.

FIG. 5 shows a graph of the injury risk for an occupant over the seat adjustment.

### DETAILED DESCRIPTION

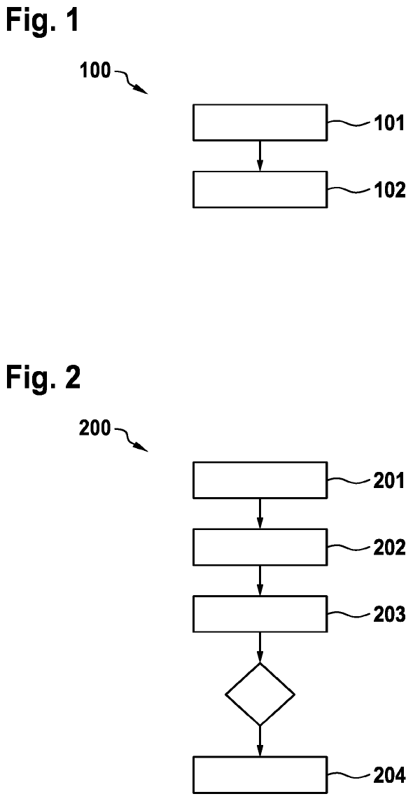

FIG. 1 shows a flow diagram of a specific embodiment of a method 100 for determining an adjustment of a vehicle seat. In step 101, the occupant type of the entering occupant is ascertained. The ascertainment takes place when the vehicle is entered. In step 102, an adjustment of the vehicle seat is determined as a function of the ascertained occupant type. The adjustment is determined in such a way that the occupant will be optimally aligned in relation to the occupant-protection arrangement allocated to the occupant.

FIG. 2 shows a flow diagram of a specific embodiment of a method 200 for warning an occupant. In steps 201 and 202, an adjustment of the vehicle seat according to method 100 for determining an adjustment of a vehicle seat is determined as a function of the ascertained occupant type. In step 203, the determined adjustment of the vehicle seat is compared to the current adjustment of the vehicle seat. If the current adjustment of the vehicle seat and the determined adjustment of the vehicle seat are not in agreement, then a warning will be output to the occupant in step 204.

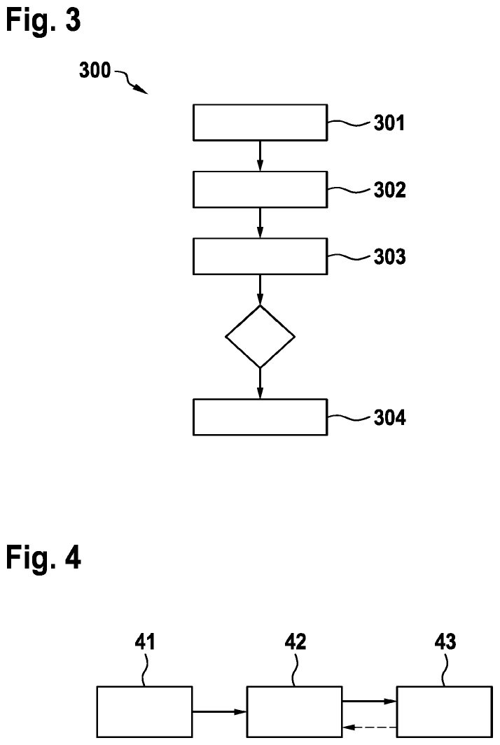

FIG. 3 shows a flow diagram of a specific embodiment of a method 300 for adjusting a vehicle seat. In steps 301 and 302, an adjustment of the vehicle seat as a function of the ascertained occupant type is determined according to method 100 for determining an adjustment of a vehicle seat. In step 303, the determined adjustment of the vehicle seat is compared to the current adjustment of the vehicle seat. If the current adjustment of the vehicle seat and the determined adjustment of the vehicle seat do not agree, then the at least partially automatically adjustable vehicle seat is controlled in step 304 in such a way that the adjustment of the vehicle seat is made to match the determined adjustment.

FIG. 4 shows a block diagram of the present invention. Reference numeral 41 denotes a device for interior monitoring as well as an associated control unit. Reference numeral 42 denotes a system for an individual occupant positioning. Reference numeral 43 denotes an at least partially electrically adjustable vehicle seat as well as an associated control unit.

The device for interior monitoring 41 and the system for individual occupant positioning 42 are connected in such a way that information or general data are able to be exchanged between device 41 and system 42. In addition, the system for individual occupant positioning 42 and the at least partially electrically adjustable vehicle seat 43 are also connected such that information or general data are able to be exchanged between system 42 and vehicle seat 43. Such a data exchange is able to be carried out via known transmission systems, e.g., CAN, FlexRay, PSI5, SPI, or also in a wireless manner via WLAN, Bluetooth, or in similar manners.

The device for interior monitoring 41 detects the mass, the size and the gender of the occupant when an occupant takes a seat in the vehicle and generates an occupant type on that basis. A seat adjustment that is optimal with regard to the restraint arrangement allocated to the occupant is then determined for the generated occupant type. It is forwarded to the system for individual occupant positioning 42. The system for individual occupant positioning 42 utilizes the information of the device for interior monitoring 41 and, optionally (indicated by the dashed arrow), the information of the at least partially electrically adjustable vehicle seat 43, in order to check whether the occupant, having strapped himself in, has assumed an optimal seating position in the sense of the present invention. If the check comes to the conclusion that the occupant is not in an optimal seating position, then the occupant will be notified of this fact via a suitable user interface (HMI). In addition, required adjustment parameters are ascertained for the at least partially electrically adjustable vehicle seat 43 in order to control vehicle seat 43 in such a way that the occupant is able to be transferred into an optimal seating position. The adjustment of vehicle seat 43 advantageously takes place while the vehicle is standing still. The adjustment is possibly carried out only once the occupant has confirmed the adjustment to be made.

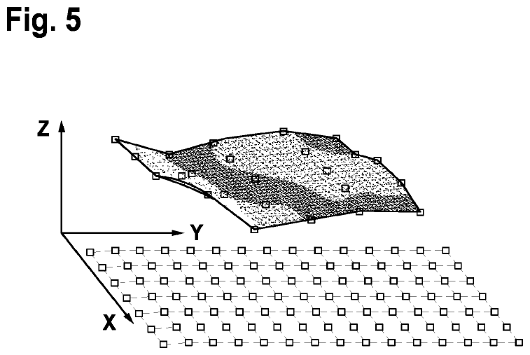

FIG. 5 shows a graph of the injury risk for an occupant over the seat adjustment.

Using the so-called Hybrid III 50% man, the effect that the seat adjustment has on the injury risk is exemplarily illustrated in the graph. Shown on the X- and the Y-axis are the seat height (X-axis) and the position of the seat on the adjustment rail (Y-axis), which represent the adjustment parameters of a vehicle seat. The injury risk to the occupant is plotted on the Z-axis.

The present invention is based on the understanding that local and global minima exist for the injury risk as a function of the occupant type, in this instance the Hybrid III 50% man, and as a function of the adjusted seat parameters. The seat adjustment is determined as a function of the ascertained occupant type in such a way that it leads to said minimum injury risk. The adjustment determined in this manner is compared to the current seat adjustment. If a deviation is present, then the occupant is able to be informed or warned. Alternatively or additionally, an adjustment to the determined adjustment parameters may be carried out in the case of an at least partially automatically adjustable vehicle seat.

1-10. (canceled)

11. A method for determining an adjustment of a vehicle seat of a vehicle having at least one occupant-protection arrangement, the method comprising:
ascertaining an occupant type of an occupant when the occupant enters the vehicle; and
determining an adjustment of the vehicle seat as a function of the ascertained occupant type, so that the determined occupant type is optimally aligned with respect to the at least one occupant-protection arrangement of the vehicle.

12. The method of claim 11, wherein the occupant type is ascertained with the aid of a device for interior monitoring, and/or with the aid of a sensor for detecting the weight of the occupant.

13. The method of claim 11, further comprising:
comparing the determined adjustment of the vehicle seat to a current adjustment of the vehicle seat; and
warning the occupant if the determined adjustment does not agree with the current adjustment.

14. The method of claim 13, wherein the current adjustment of the vehicle seat is ascertained with the aid of a device for interior monitoring, or is ascertained with the aid of at least one device for detecting a seat adjustment.

15. The method of claim 11, wherein the vehicle seat is at least partially automatically adjustable, and wherein the vehicle seat is automatically brought into the determined adjustment.

16. The method of claim 15, wherein the vehicle seat is brought into the determined adjustment as a function of a confirmation from the occupant.

17. The method of claim 15, wherein the vehicle seat is brought into the determined adjustment as a function of the driving state of the vehicle.

18. A non-transitory computer readable medium having a computer program, which is executable by a processor, comprising:
a program code arrangement having program code for determining an adjustment of a vehicle seat of a vehicle having at least one occupant-protection arrangement, by performing the following:
ascertaining an occupant type of an occupant when the occupant enters the vehicle; and
determining an adjustment of the vehicle seat as a function of the ascertained occupant type, so that the determined occupant type is optimally aligned with respect to the at least one occupant-protection arrangement of the vehicle.

19. The computer readable medium of claim 18, wherein the occupant type is ascertained with the aid of a device for interior monitoring, and/or with the aid of a sensor for detecting the weight of the occupant.

20. A device for determining an adjustment of a vehicle seat of a vehicle having at least one occupant-protection arrangement, comprising:
a control unit configured to perform the following:
ascertaining an occupant type of an occupant when the occupant enters the vehicle; and
determining an adjustment of the vehicle seat as a function of the ascertained occupant type, so that the determined occupant type is optimally aligned with respect to the at least one occupant-protection arrangement of the vehicle.

21. The method of claim 11, wherein the occupant type is ascertained with the aid of a device for interior monitoring, in particular with the aid of a camera for vehicle interior monitoring, and/or with the aid of a sensor for detecting the weight of the occupant.

22. The method of claim 13, wherein the current adjustment of the vehicle seat is ascertained with the aid of a device for interior monitoring, in particular with the aid of a camera for monitoring the vehicle interior, or is ascertained with the aid of at least one device for detecting a seat adjustment.

23. The method of claim 11, wherein the vehicle seat is at least partially automatically adjustable, in particular electrically adjustable, and wherein the vehicle seat is automatically brought into the determined adjustment.

24. The method of claim 15, wherein the vehicle seat is brought into the determined adjustment as a function of the driving state of the vehicle, in particular as a function of the vehicle being in the standstill driving state.
